(19) United States
(12) Patent Application Publication
(10) Pub. No.: US 2012/0163708 A1
(43) Pub. Date: Jun. 28, 2012

(54) APPARATUS FOR AND METHOD OF GENERATING CLASSIFIER FOR DETECTING SPECIFIC OBJECT IN IMAGE

(75) Inventors: Wei FAN, Beijing (CN); Akihiro Minagawa, Kawasaki (JP); Jun Sun, Beijing (CN); Yoshinobu Hotta, Kawasaki (JP); Satoshi Naoi, Beijing (CN)

(73) Assignee: Fujitsu Limited, Kawasaki (JP)

(21) Appl. No.: 13/335,077

(22) Filed: Dec. 22, 2011

(30) Foreign Application Priority Data
Dec. 24, 2010 (CN) 201010614810.8

(51) Int. Cl. G06K 9/62

(52) U.S. Cl. 382/159

(57) ABSTRACT

There provides an apparatus for and a method of generating a classifier for detecting a specific object in an image. The apparatus for generating a classifier for detecting a specific object in an image includes: a region dividing section for dividing, from a sample image, at least one square region having a side length equal to or shorter than the length of shorter side of the sample image; a feature extracting section for extracting an image feature from at least a part of the square regions divided by the region dividing section; and a training section for performing training based on the extracted image feature to generate a classifier. By using the apparatus for and method of generating the classifier, it becomes possible to make full use of recognizable regions of objects to be recognized with variable aspect ratios and improve speed and accuracy for recognizing in complex backgrounds.

### CROSS REFERENCE TO RELATED APPLICATIONS

This application claims the benefit of Chinese Application No. 201010614810.8, filed Dec. 24, 2010, the disclosure of which is incorporated herein by reference.

### TECHNICAL FIELD

The present invention relates to image process and pattern recognition, in particular to apparatus for and method of generating a classifier for detecting a specific object in an image.

### BACKGROUND

At present, image process and pattern recognition techniques have been applied more and more widely. In some applications, there is a need to recognize such an image detection object: this class of image detection objects has larger difference in aspect ratio from one another and various image composing elements (graphics, symbols, characters, and so on). Currently, techniques which detect objects with little difference in aspect ratio such as the technique detecting human face or passenger are usually used to recognize.

For such an image detection object, in the currently used classifier training algorithm, a training image is usually scaled to a rectangle with standardized size, for example, 24×24 pixels. The rectangle corresponds to a detecting frame (scanning frame) used in object detecting. Taking a special commercial symbol used as an image detection object as an example, FIG. 1 is a schematic view illustrating symbols with different aspect ratios scaled to rectangles with standardized size.

However, as to image detection objects with aspect ratio having larger variable section, if they are scaled by force into rectangles with standardized size, as to objects in strip shape, larger blank area will appear at upper and lower sides of the rectangle, as shown in the first and last figures in FIG. 1 and (a) in FIG. 2. FIG. 2 is a schematic view illustrating extracting feature from the same image detection object using different feature extracting regions (regions of interest). In this way, effective regions actually available for feature extracting may be reduced.

In addition, at present, Content Based Image Retrieval (CBIR) technique is also universally used for the image detection object with an aspect ratio having a larger variable section. This technique needs to be provided with precise detection location and segmentation result of an image detection object in advance.

However, the above image detection object with variable aspect ratio may appear in various complex backgrounds, such as nature scene. The CBIR technique cannot be used in complex background that requires rapid and effective recognition since it depends upon exact location and segmentation.

### SUMMARY

Considering the above defects in the existing technology, the invention is intended to provide an apparatus for and method of generating a classifier for detecting a specific object in an image, which make fuller use of recognizable regions of image detection objects with variable aspect ratio to be detected, so as to improve recognition accuracy in complex background.

One embodiment of the invention is an apparatus for generating a classifier for detecting a specific object in an image. The apparatus comprises: a region dividing section for dividing, from a sample image, at least a square region having a side length equal to or shorter than the length of shorter side of the sample image; a feature extracting section for extracting an image feature from at least a part of the square regions divided by the region dividing section; and a training section for performing training based on the extracted image feature to generate a classifier.

Further, the feature extracting section extracts the image feature from the square regions by using a Local Binary Patterns algorithm, in which at least one of size, aspect ratio and location of a center sub-window is variable.

Further, the apparatus for generating a classifier for detecting a specific object in an image further comprises a region selecting section for selecting from all the square regions obtained by the region dividing section a square region that meets a predetermined criterion, as the at least a part of the square regions from which the feature extracting section extracts an image feature.

Further, the predetermined criterion comprises one that the selected square region shall be rich in texture, and the correlation among the selected square regions shall be small.

Further, the degree of the richness of the texture in the square region is measured by an entropy of local image descriptors.

Further, the local image descriptor is a local edge orientation histogram of an image.

Further, the predetermined criterion further comprises one that a class conditional entropy of the selected square regions is higher, the class conditional entropy being a conditional entropy of a square region to be selected with respect to a set of the selected square regions.

Another embodiment of the invention is a method of generating a classifier for detecting a specific object in an image. The method comprises: dividing, from a sample image, at least a square region having a side length equal to or shorter than the length of shorter side of the sample image; extracting an image feature from at least a part of the divided square regions; and performing training based on the extracted image feature to generate a classifier.

The invention makes full use of recognizable regions of image detection objects with different aspect ratios by dividing a sample image into a plurality of square regions having a side length equal to or shorter than the length of shorter side of the sample image and by performing training using the features of the divided square regions to generate a classifier. Moreover, speed and accuracy for recognizing an object in a complex background can be improved by recognizing the object using the classifier.

### BRIEF DESCRIPTION OF THE DRAWINGS

Referring to the explanations of the present invention in conjunction with the drawings, the above and other objects, features and advantages of the present invention will be understood more easily. In the drawings, the same or corresponding technical features or components are represented by the same or corresponding reference signs. The sizes and relative locations of the units are not necessarily scaled in the drawings.

FIG. 1 is a schematic view illustrating symbols with different aspect ratios scaled to a rectangle with standardized size.

FIG. 2 is a schematic view illustrating extracting feature from the same image detection object using different feature extracting regions.

FIG. 3 is a block diagram illustrating structure of the classifier generating apparatus according to embodiments of the invention.

FIG. 4 is a schematic view illustrating the principle of extracting feature using a Local Binary Pattern feature.

FIG. 5 is a flowchart illustrating the classifier generating method according to embodiments of the invention.

FIG. 6 is a block diagram illustrating structure of the classifier generating apparatus according to another embodiment of the invention.

FIG. 7 is a schematic view illustrating calculating edge orientation histogram for the divided square regions according to embodiments of the invention.

FIG. 8 is a flowchart illustrating a method for generating an image classifier according to another embodiment of the invention.

FIG. 9 is a block diagram illustrating structure of the image detecting apparatus according to embodiments of the invention.

FIG. 10 is a flowchart illustrating the image detecting method according to embodiments of the invention.

FIG. 11 is a block diagram illustrating example of structure of a computer which implements the invention.

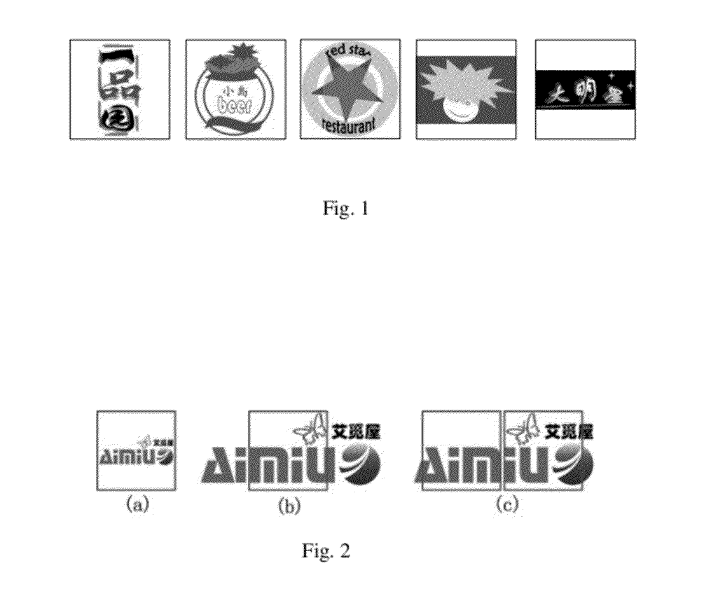

### DESCRIPTION OF THE PREFERRED EMBODIMENTS

The embodiments of the present invention are discussed hereinafter in conjunction with the drawings. It shall be noted that representation and description of components and processes unrelated to the present invention and well known to one of ordinary skill in the art are omitted in the drawings and the description for the purpose of being clear.

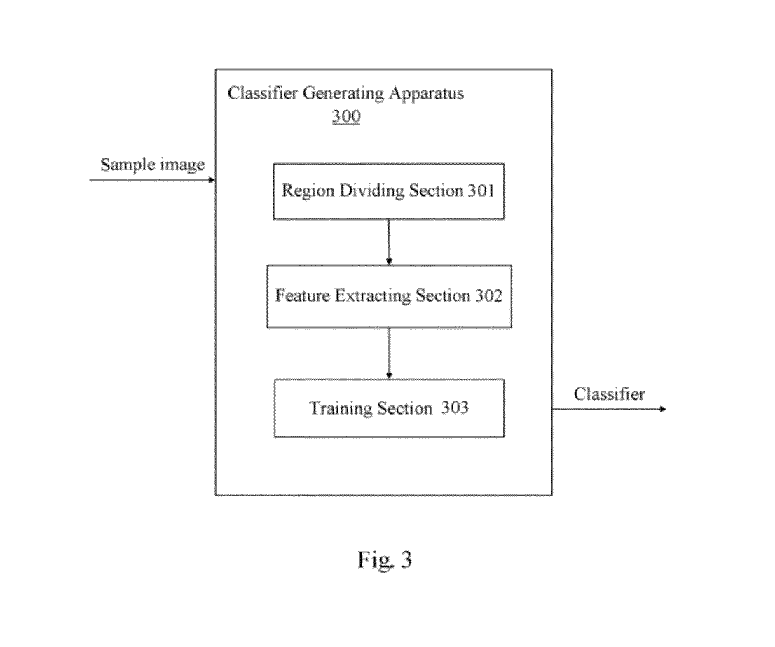

FIG. 3 is a block diagram illustrating structure of the classifier generating apparatus 300 according to embodiments of the invention. The classifier generating apparatus 300 comprises: a region dividing section 301, a feature extracting section 203 and a training section 303.

The region dividing section 301 is used for dividing, from a sample image, at least a square region having a side length equal to or shorter than the length of shorter side of the sample image. The feature extracting section 302 is used for extracting an image feature from at least a part of the square regions divided by the region dividing section 301. The training section 303 performs training based on the extracted image feature to generate a classifier.

The sample image comprises images containing image detection objects for training a classifier. The image detection objects are target images segmented from various backgrounds to be detected in detection processing. When a sample image is prepared, the sample image may be scaled based on the size of the feature extracting region prepared for use, so as to make the sample image become a sample image suitable for feature extracting.

In the embodiment, the sample image is input to the classifier generating apparatus 300 to train and generate a classifier. After receiving the sample image, the region dividing section 301 divides the input sample image.

To make full use of recognizable regions of the sample image to train a classifier, the region dividing section 301 divides from the sample image at least a square region as a unit for local feature extracting. Moreover, the square region has a side length equal to or shorter than the length of shorter side of the sample image. It should be noted that: the side length of the square area having a length “equal to” the length of shorter side of the sample image as mentioned here is not necessarily “equal” in a strict sense but being “substantially” or “approximately” equal. For example, if the proportion of the difference between a length and a side length to the side length is lower than a predetermined threshold, it is deemed that the length is substantially or approximately equal to the side length. The value of the predetermined threshold depends upon settings in specific applications. Setting the square region to have a side length “equal to” the length of the shorter side of the sample image has an advantage that the square feature extracting region includes as much as possible texture features of the sample images. In practice, even if the square region has a side length shorter than the length of the shorter side of the sample image, it is acceptable as along as the square region includes texture features enough for representing image detection objects to be detected.

In different embodiments, the square region may be arranged differently on the sample image according to requirements and characteristics of the sample image.

As shown in (c) of FIG. 2, in the embodiment, a plurality of square regions are arranged adjacently along the longer side of the sample image in a non-overlapping manner. Such a setting has a further advantage that the square feature extracting region not only accommodates extremely texture features of images in the image detection objects, but also contains no or few (the edge section of the last arranged square region that extends beyond the sample image) blank areas which do not belong to the image detection objects. Alternatively, in other embodiments, the square region may be arranged in a certain interval.

In addition, a plurality of square regions may also be arranged on the sample image in an overlapping manner. A typical example is that the square region is divided every a fixed step in a scanning manner, that is, the plurality of square regions as divided overlap each other with a proportion of fixed side length.

Or, it may be understood like this: in some embodiments, the square region is divided every a fixed step. When the step is shorter than the side length of the square region, the divided square regions overlap each other, when the step is equal to the side length of the square region, the divided square regions are arranged adjacently, and when the step is longer than the side length of the square region, the square regions are spaced by a fixed distance every two. Of course, in another embodiment, the square region may be divided by a variable step or in an overlapping manner.

In one embodiment, when the length of the longer side of the sample image is shorter than 2 times of the length of the shorter side of the sample image, the region dividing section 301 may divide from the sample image only one square region as a unit for local feature extracting.

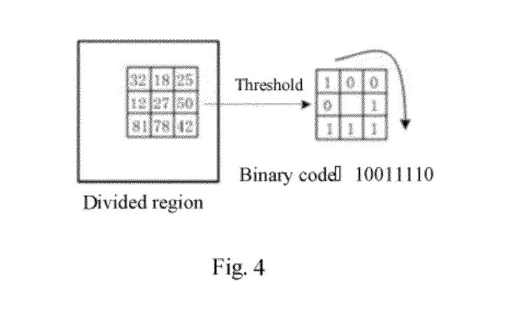

The feature extracting section 302 extracts image feature from at least a part of the square region divided by the region dividing section 301. Of course, when only one square region is divided, image feature is extracted from the square region. The feature extracting section 302 may represent feature of the divided square region using various local texture feature descriptors that are universally used at present. In the embodiment, feature is extracted by using a Local Binary Patterns (LBP). FIG. 4 is a schematic view illustrating the principle of extracting feature using the LBP.

LBP algorithm usually defines 3×3 window, as shown in FIG. 4. By taking the gray value of the center sub-window as a threshold, binary process is performed on other pixels in the window, that is, the gray values of pixels in other sub-windows in the window are compared with the gray value of the center sub-window in the window respectively. When it is greater than or equal to the gray value of the center pixel, 1 is assigned to its corresponding location, otherwise, 0 is assigned. And then, a group of 8 bit (one byte) binary codes related to the center sub-window is obtained, as shown in FIG. 4. Further, the group of binary codes may be weight-added based on different locations of other sub-windows to obtain LBP value of the window. The texture structure of a certain region in the image may be described using the histogram of the LBP code of the region.

As to the LBP algorithm universally used at present, its center sub-window covers a single target pixel. Correspondingly, sub-windows around the center sub-window also cover a single pixel. In embodiments of the invention, LBP is configured in an extending manner: allowing size, aspect ratio and location of the center sub-window to be varied. Specifically, in the embodiment, the center sub-window covers one region instead of a single pixel. In the region, a plurality of pixels may be included, that is, a pixel matrix with variable rows and columns may be included, and the aspect ratio and location of the pixel matrix may be varied. In this case, the size, aspect ratio and location of the sub-windows adjacent to the center sub-window may vary correspondingly, but the criterion for calculating the LBP value does not change. For example, an average value of pixel grays of the center sub-window may be used as the threshold. In this case, as to a feature extracting region with a fixed size, for example 24×24, the feature amount of the LBP that may be included (that is, the combination of various sizes, aspect ratios and locations) will be far greater than the number of pixels in the square region. The number of features in the massive feature database consisted of LBP increase greatly due to this process. Accordingly, the feature quantity that can be selected for use when using various training algorithms will increase greatly. Although image feature extracting is described by taking LBP as an example here, it should be understood that other feature extracting methods for object recognition are also applicable for embodiments of the invention.

The training section 303 performs training based on the extracted image feature to generate a classifier. The training section 303 may use various classifier training methods that are universally used at present. In the embodiment, Joint-Boost classifier training method is used to perform training. As to specific introduction to the Joint-Boost algorithm, you may make reference to Torralba, A., Murphy, K. P., and Freeman, W. T., “Sharing features: efficient boosting procedures for multiclass object detection”, [IEEE CVPR], 762-769 (2004).

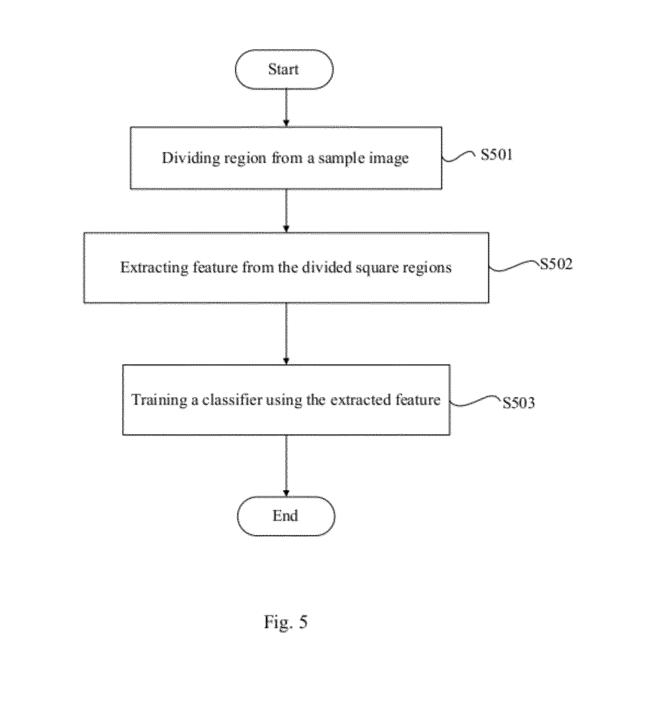

FIG. 5 is a flowchart illustrating the classifier generating method according to embodiments of the invention.

At step S501, divide from a sample region at least a square region having a side length equal to or shorter than the length of a shorter side of the sample image. For example, one side of one of the divided square regions overlaps with the shorter side of the sample image, and other square regions are arranged with a certain step length along the longer side of the sample image in a manner similar to scanning (if the aspect ratio of the sample image is greater than 1). When the step length is shorter than the side length of the square region, the square regions are arranged in an overlapping manner, and when the step length is equal to or longer than the side length of the square region, the square regions are arranged adjacently or with a certain distance.

In specific operations, the side length of the square feature extracting region may be pre-set, for example, as 24×24. Then, the collected sample images are scaled based on the set side length, such that the shorter side of the sample image is equal to the set side length of the square feature extracting region.

In other embodiments, the square region may have a side length shorter than the length of the shorter side of the sample image as long as the square region contains enough texture features for representing image detection objects to be detected.

At step S502, extract an image feature from at least a part of the divided square regions. The image feature may be extracted by using the known various methods and local feature descriptors. In the embodiment, feature is represented for the divided square regions by using Local Binary Pattern features. Wherein, the size of the region covered by the center sub-window of the LBP feature is variable, and is not limited to a single target pixel. Meanwhile, the aspect ratio and location of the region covered by the center sub-window are also variable. It has an advantage of broadening significantly the amount of features in the feature database for training a classifier.

At step S503, perform a training based on the extracted image feature to generate a classifier. For example, Joint-Boost algorithm may be used to train a classifier.

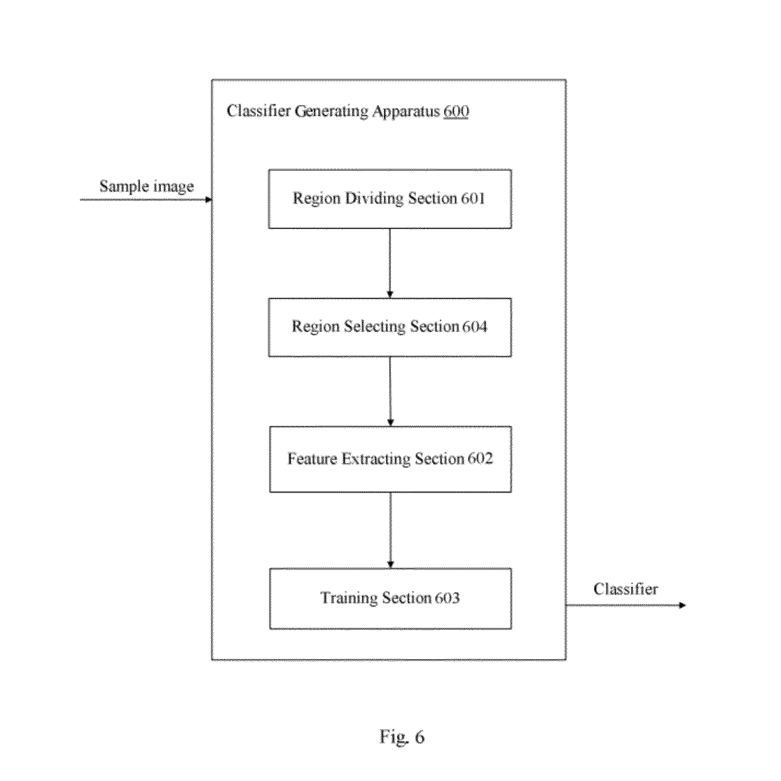

FIG. 6 is a block diagram illustrating structure of the classifier generating apparatus 600 according to another embodiment of the invention. The classifier generating apparatus 600 comprises a region dividing section 601, a region selecting region 604, a feature extracting section 602 and a training section 603.

Similar to the region dividing section 301 that is described in conjunction with FIG. 3, the region dividing section 601 divides from a sample image input to the classifier generating apparatus 600 at least a square region and makes the square region have a side length equal to or shorter than the length of shorter side of the sample image.

The region selecting section 604 selects from all the square regions obtained by the region dividing section 601 a square region that meets a predetermined criterion, as the square region from which the feature extracting section 602 extracts image feature. Hereinafter discusses the criterion used by the region selecting section 604.

Based on different requirements, various criterions may be used to select feature extracting regions (the divided feature extracting regions that are not selected may be referred to as candidate region of interest). In common classifier training, to improve detection efficiency of image detection object, the square region having visual significance is selected in preference to train a classifier. Normally, the richer the texture in the square region is, the stronger the visual significance will be. The degree of the richness of the texture in the square region may be measured by an entropy of local image descriptors. In some embodiments, the local image descriptor may be, for example, local edge orientation histogram (EOH).

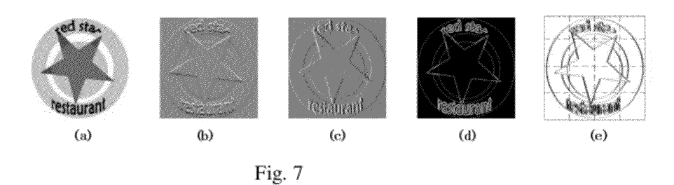

FIG. 7 is a schematic view illustrating calculating edge orientation histogram for divided square regions according to embodiments.

Texture feature in an image is detected by using classical edge detection. In a given image, gradient amplitude value of each pixel point reflects edge acutance of the region to some extend, and the direction of the gradient reflects edge direction at each point, and the combination of the two represents complete texture information of the image. As shown in FIG. 7, in the embodiment, the edge gradient of the image is detected by using Sobel operator first. Edge with lower gradient intensity is filtered out ((b) to (d) in FIG. 7). The edge with lower intensity usually corresponds to noise. Then the square region is divided equally into 4×4 units ((e) in FIG. 7), and the normalized local gradient orientation histogram is calculated in each unit. In the embodiment, the level of the quantity of the histogram is 9, that is, 0°-180° is divided equally into 9 sections.

The Sobel operator is one of operators used in image processing, and is mainly used for edge detecting. It is a discrete differential operator for operation of gradient approximation of an image brightness function. Optionally, the image edge may be detected using other image processing operators.

As to the square region Rₓ centering on a location x, a joint histogram P_{Rx} has 4×4 local histograms Pᵣₖ (k=1 . . . 16). Assume that each local histogram is independent from each other, the entropy of the joint histogram H(Rₓ) may be calculated by the formula (1):

$$H ( {R}_{x} ) = {\sum }_{k} H ( {r}_{k} ) = {\sum }_{k} [ - {\sum }_{i} {P}_{rk} {log}_{2} {P}_{rk} ] \qquad ( 1 )$$

As to one sample image, a common method for selecting a feature extracting region (region of interest) is: to rank based on magnitude of the entropy the locations of all the possible regions of interest of the sample image to select regions of interest with the first N biggest entropies to represent one image detection object.

However, a case may occur: two square regions having high visual significance have similar or close texture. When the two square regions are ranked based on the magnitude of the entropy, the two square regions are both selected for feature extracting and for classifier training. Therefore, redundant computation is caused, and other texture features available for recognition are wasted because locations of other candidate regions of interest with slightly lower significance are seized.

Furthermore, as to two square regions that belong to different sample images, if the two square regions have similar texture, and have a larger entropy as compared with other square regions of the own sample image, the two square regions will be both selected to train a classifier. Apparently, it is difficult to ensure accuracy of detection by detecting image detection object using two classifiers trained based on similar texture features. In other words, it is difficult for the classifier trained using square region having similar texture feature to distinguish among different classes of image detection objects. That is, it is impossible for the square region selected based on simple ranking rules to ensure of maximally distinguishing among square regions that belong to different image detection objects.

Therefore, the correlation among various selected square regions shall be as small as possible while ensuring of selecting square regions with the degree of richness of texture as large as possible. To balance the two, the concept of class conditional entropy is introduced into the embodiment: the class conditional entropy is a conditional entropy of a square region to be selected with respect to a set of the selected square regions. The criterion based on which the region selecting section 604 selects is the class conditional entropy maximization. That is, if the current square region to be selected is similar to a certain selected square region, even if it has very high visual significance itself, it will not have larger class conditional entropy because it does not have strong difference from other classes. This criterion balances greatly the degree of richness of texture in square regions and differences between classes of the square regions.

To facilitate description, H(Rₓ|Sₖ) represents the class conditional entropy, wherein Rₓ is representative of a square region centering on x to be selected, and Sₖ is representative of a set of the selected square regions.

To obtain recognition information between classes like the class conditional entropy, one embodiment is that the square region is selected in sequence using an iterative algorithm. The significance of the current square region is made be maximum with respect to the selected square regions. The algorithm flow of the embodiment is listed as follows:

1. ranking all the sample images in order of aspect ratio (≧1) from low to high.
2. setting a dynamic set S whose initialization is vacant, then, storing all the selected square regions into the S.
3. making i=1, . . . , N (i is a label of sample image), repeating the following steps:
(a) making ROI_{1,1}=argmax_{Rx}H₁(Rₓ), adding the ROI_{1,1} to the set S (ROI is representative of feature extracting regions (regions of interest)),
wherein argmax_{Rx}H₁(Rₓ) is representative of Rₓ which makes the entropy H₁(Rₓ) to be maximum;
(b) making ROI_{i,j}=argmax_{Rx}{min_{Sk}εs H(Rₓ|Sₖ)}, i≧1, j±1 (j is the label of ROI in the same sample image),
wherein, H(Rₓ|Sₖ) is a conditional entropy, min_{Sk}εs H(Rₓ|Sₖ) is representative of a minimum value of the conditional entropy of the Rₓ with respect to the subset Sₖ of the set S, and argmax_{Rx}{min_{Sk}εs H(Rₓ|Sₖ)} is representative of the Rₓ which makes the minimum value to be maximum;

adding ROI_{i,j} to S, j:=j+1

if no ROI_{i,j} can be found for the image detection object Ti, i:=i+1.

The set S obtained after the cycle of i=1 . . . N is completed is the set of all the selected square regions.

Taking FIG. 2 as an example, the square region including text in (c) of FIG. 2 may be regarded as a region of interest when considering only the degree of richness of the texture. When the set of the selected square regions has a square region which has larger correlation with the square region, as to the sample image shown in FIG. 2, the region of interest finally selected may be the square region shown in (b) of FIG. 2, or square region including other sections of the sample image.

Subsequently, the region selecting section 604 inputs the square region selected based on the above class conditional entropy maximization criterion to the feature extracting section 602. The feature extracting section extracts features from the selected square region, and its specific extracting process is similar to that of the feature extracting section 302 which is described in conjunction with FIG. 3, and thus the description is omitted here.

The training section 603 performs training on a classifier using the feature obtained by the feature extracting section 602.

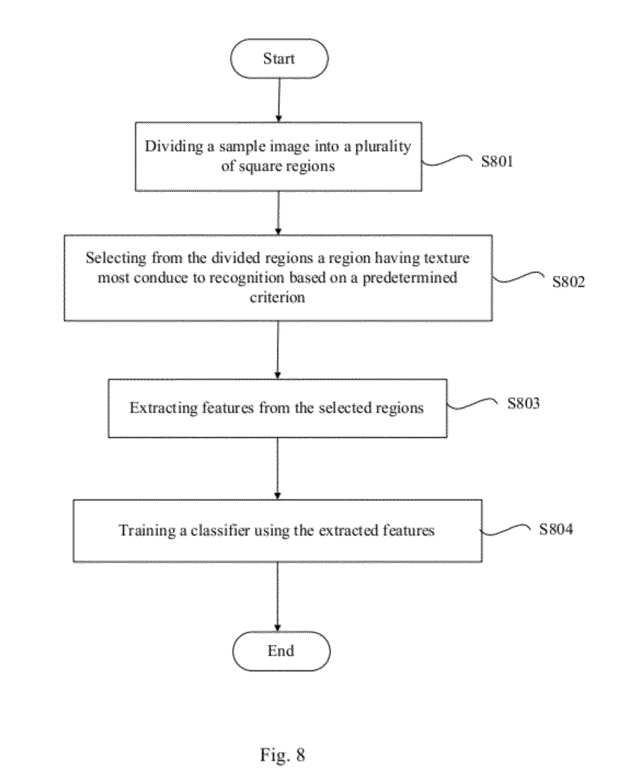

FIG. 8 is a flowchart illustrating a method for generating an image classifier according to another embodiment of the invention.

At step S801, divide from the sample image at least a square region, and make the square region have a side length equal to or shorter than a length of the shorter side of the sample image. It shall be noted that: depending upon the feature of the detected object, the “be equal to” is not absolute, the square region may have a side length shorter than a length of the shorter side of the sample image as long as the square region includes enough texture feature for recognizing image detection object, for example, such cases include one that the object is consisted of repetitive patterns.

At step S802, select among all the divided square regions based on a predetermined criterion, such that the classifier trained by the selected square regions has higher detection efficient and accuracy. The predetermined criterion may be made based on the degree of richness of texture in the square region to be selected and the correlation between classes among different sample images. For example, select a square region having larger degree of richness of texture and smaller correlation between classes. In the embodiment, the criterion of class conditional entropy maximization can be used to select.

At step S803, image features are extracted from the selected square regions. In the embodiment, feature is represented for the divided square regions using a Local Binary Pattern feature. Wherein, the size, aspect ratio and location of the region covered by the center sub-window of the Local Binary Pattern feature are variable. Correspondingly, the sizes, aspect ratios and locations of sub-windows adjacent to the center sub-window are also variable.

At step S804, perform a training using the image feature of the selected square region (region of interest) to generate a classifier.

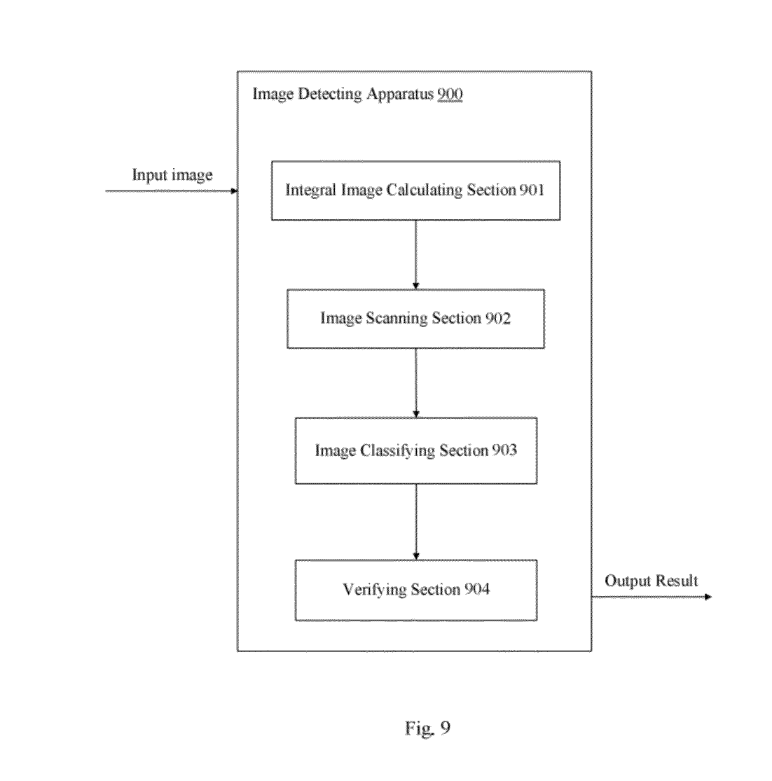

FIG. 9 is a block diagram illustrating structure of image detecting apparatus 900 according to an embodiment of the invention.

The image detecting apparatus 900 according to the embodiment comprises: integral image calculating section 901, image scanning section 902, image classifying section 903 and verifying section 904.

After the image to be detected is input to the image detecting apparatus 900, the integral image calculating section 901 performs decoloration process to the image to convert color image into gray image. Then, integral image is calculated based on the gray image to facilitate subsequent feature extracting processes. The integral image calculating section 901 inputs the obtained integral image to the image scanning section 902.

The image scanning section 902 scans the image to be detected that has been processed by the integral image calculating section 901 using a scanning window with variable size. In the embodiment, the scanning window scans the image to be detected from left to right and from the top to the bottom. Moreover, after the completion of one scan, the size of the scanning window increases by a certain proportion to scan the integral image for the second time. Then the image scanning section 902 inputs the image region covered by each scanning window obtained by scanning to the image classifying section 903.

The image classifying section 903 receives a scanning image, and classifies each input image region by applying a classifier. Specifically, the image classifying section 903 extracts feature from the input image region using the feature extracting method used when training the classifier. For example, when the feature of the region of interest is described using LBP descriptor during generating a classifier, the image classifying section 903 also uses LBP descriptor to extract features from the input image region. Moreover, sizes, aspect ratios and locations of the center sub-window of the used LBP descriptor and the adjacent sub-windows are bound to the sizes, aspect ratios and locations of the center sub-window and the adjacent sub-windows when generating a classifier. When the size of the scanning window is different from that of the square region used as the region of interest, the sizes, aspect ratios and locations of the center sub-window of the LBP descriptor and the adjacent sub-windows that extract feature from the scanning window are scaled by proportion based on the ratio between sizes of the scanning window and of the region of interest.

Apply the classifier according to embodiment of the invention to the extracted feature of scanning image, and the scanning image region will be classified into two: image detection object to be detected or background. In embodiments of the invention, this series of binary classifiers is trained using Joint-Boost algorithm. The Joint-Boost training method can make the binary classifier share the same group of features. It is an image detection object class candidate list corresponding to a certain scanning window that is output via the Joint-Boost classifier. The image classifying section 903 inputs the classification results to the verifying section 904.

The verifying section 904 verifies the classification results. A variety of verifying methods can be used. In the embodiment, the verifying algorithm based on SURF local feature descriptor is used to select image detection object with the highest confidence from the candidate list to output as the final result. As to specific introductions to the SURF, please make references to Herbet Bay, Andreas Ess, Tinne Tuytelaars, Luc Van Gool, “SURF: Speeded Up Robust Features”, Computer Vision and Image Understanding (CVIU), Vol. 110, No. 3, pp. 346-359, 2008.

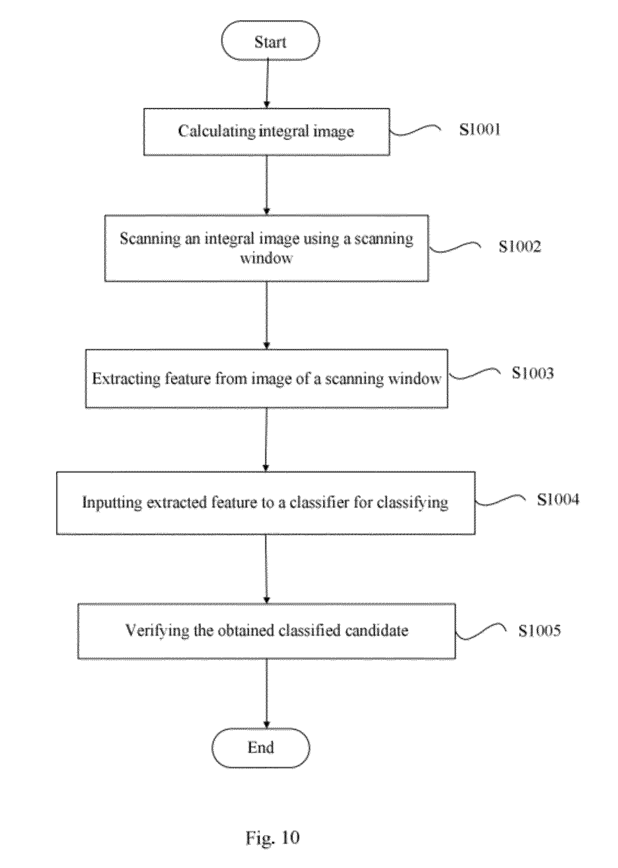

FIG. 10 is a flowchart illustrating an image detecting method according to embodiments of the invention.

At step S1001, process the image to be detected to calculate integral image of the image to be detected.

At step S1002, scan the integral image using a scanning window whose size changes from small to large by a predetermined proportion every full scan. The initial size of the scanning window is set based on the size of the image to be scanned and the size of the image detection object to be detected, and zooms in by a certain proportion every full scan. In the embodiment, the scanning order is from left to right and from front to back. Apparently, other scanning orders may be used.

At step S1003, extract features of the image region covered by the scanning window. The algorithm used for feature extracting shall be consistent with the feature extracting algorithm used when generating the classifier. In the embodiment, a Local Binary Pattern algorithm is used.

At step S1004, the feature extracted at step S1003 is input into the classifier of the invention to be classified by the classifier. After classified by the classifier, an image detection object class candidate list can be obtained.

At step S1005, verify the obtained class candidate items. A variety of verifying methods currently used can be used. In the embodiments, the verifying algorithm based on SURF local feature descriptor is used to select image detection object class with the highest confidence from the candidate list to output as the final result.

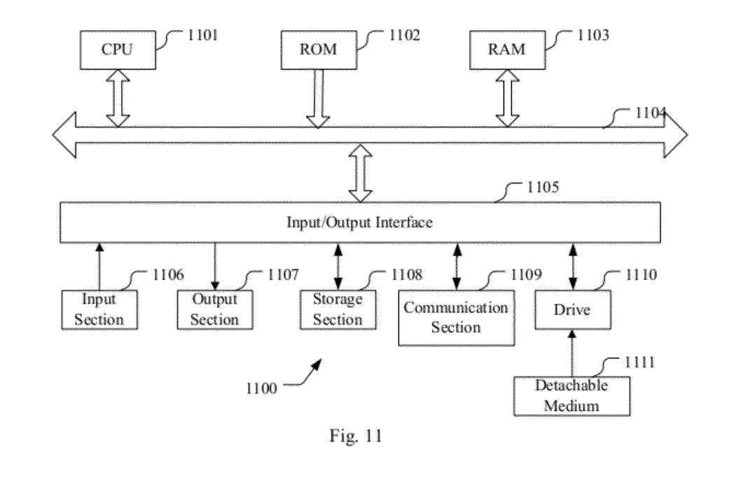

Hereinafter, an example of structure of a computer which implements the data processing apparatus of the invention is described by referring to FIG. 11.

In FIG. 11, a central processing unit (CPU) 1101 performs various processes according to the program stored in the Read Only Memory (ROM) 1102 or the program loaded from the storage section 1108 to the Random Access Memory (RAM) 1103. In RAM 1103, data required by the CPU 1101 when performing various processes are stored based on requirements.

CPU 1101, ROM 1102 and RAM 1103 are connected one another via a bus 1104. An input/output interface 1105 is also connected to the bus 1104.

The following components are connected to the input/output interface 1105: input section 1106, including keyboard, mouse, etc.; output section 1107, including display, such as cathode ray tube (CRT), liquid crystal display (LCD), etc., and speaker, etc.; storage section 1108, including hard drive, etc.; and communication section 1109, including network interface cards such as LAN cards, and modem, etc. The communication section 109 performs communication processes via a network such as the Internet.

In accordance with requirements, the drive 1110 is also connected to the input/output interface 1105. Detachable medium 1111 such as disk, CD-ROM, magnetic disc, semiconductor memory, and so on are installed on the drive 1110 based on requirements, such that the computer program read out from them are installed in the storage part of the 1108 based on requirements.

When the above steps and processes are implemented through software, programs constituting the software are mounted from network like the Internet or from storage medium like the detachable medium 1111.

One of ordinary skill in the art should be understood that the storage medium are not limited to the detachable medium 1111 stored with program and distributed to a user separated from the method to provide program as shown in FIG. 11. The examples of the detachable medium 1111 comprise disks, CD-ROM (including CD Read Only Memory (CD-ROM) and digital versatile disc (DVD)), magneto-optical disk (including mini-disc (MD) and semiconductor memory. Or the storage medium may be ROM 1102, hard drives contained in the storage section 1108, and so on, in which program is stored, and are distributed to a user together with the methods including the same.

In the figures, image detection objects with larger aspect ratio variation are illustrated by taking the commercial symbols as examples. In practical applications, image recognition objects with variable aspect ratio are further included, such as various vehicles.

Moreover, the invention applies to a lot of fields which apply image recognition technologies, for example, network search based on images. For example, shoot images in various backgrounds, and input the images to the pre-generated classifier according to the invention to recognize images, and search based on the recognized image detection objects to display on the webpage various types of information related to the image detection objects.

The invention is described above by referring to specific embodiments in the Description. However, one of ordinary skill in the art should be understood that various amendments and changes can be made without departing from the range of the invention defined by the Claims.

What is claimed is:

1. An apparatus for generating a classifier for detecting a specific object in an image, comprising:
a region dividing section for dividing, from a sample image, at least one square region having a side length equal to or shorter than the length of shorter side of the sample image;
a feature extracting section for extracting an image feature from at least a part of the square regions divided by the region dividing section;
a training section for performing training based on the extracted image feature to generate a classifier.

2. The apparatus according to claim 1, wherein the feature extracting section extracts the image feature from the square regions by using a Local Binary Patterns algorithm, in which at least one of size, aspect ratio and location of a center sub-window is variable.

3. The apparatus according to claim 1, further comprising: a region selecting section for selecting from all the square regions obtained by the region dividing section a square region that meets a predetermined criterion, as the at least a part of the square regions.

4. The apparatus according to claim 3, wherein the predetermined criterion comprises one that the selected square region shall be rich in texture, and the correlation among the selected square regions shall be small.

5. The apparatus according to claim 4, wherein the degree of the richness of the texture in the square region is measured by an entropy of local image descriptors.

6. The apparatus according to claim 5, wherein the local image descriptors are local edge orientation histograms of an image.

7. The apparatus according to claim 5, wherein the predetermined criterion further comprises one that a class conditional entropy of the selected square regions is higher, the class conditional entropy being a conditional entropy of a square region to be selected with respect to a set of the selected square regions.

8. The apparatus according to claim 6, wherein the predetermined criterion further comprises one that a class conditional entropy of the selected square regions is higher, the class conditional entropy being a conditional entropy of a square region to be selected with respect to a set of the selected square regions.

9. A method of generating a classifier for detecting a specific object in an image, comprising:
dividing, from a sample image, at least one square region having a side length equal to or shorter than the length of a shorter side of the sample image;
extracting an image feature from at least a part of the divided square regions;
performing training based on the extracted image feature to generate a classifier.

10. The method according to claim 9, wherein the image feature is extracted from the square regions by using a Local Binary Patterns algorithm, in which at least one of size, aspect ratio and location of a center sub-window is variable.

11. The method according to claim 9, further comprising: selecting from all the divided square regions a square region that meets a predetermined criterion, as the at least part of the square regions.

12. The method according to claim 11, wherein the predetermined criterion comprises one that the selected square region shall be rich in texture, and the correlation among the selected square regions shall be small.

13. The method according to claim 12, wherein the degree of the richness of the texture in the square region is measured by an entropy of local image descriptors.

14. The method according to claim 13, wherein the local image descriptors are local edge orientation histograms of the image.

15. The method according to claim 12, wherein, the predetermined criterion further comprises one that a class conditional entropy of the selected square regions is higher, the class conditional entropy being a conditional entropy of a square region to be selected with respect to a set of the selected square regions.

16. The method according to claim 13, wherein, the predetermined criterion further comprises one that a class conditional entropy of the selected square regions is higher, the class conditional entropy being a conditional entropy of a square region to be selected with respect to a set of the selected square regions.
